(19) United States
(12) Patent Application Publication
(10) Pub. No.: US 2007/0051723 A1
(43) Pub. Date: Mar. 8, 2007

(54) Valve for a drinking receptacle

(76) Inventor: Kjetil Naesje, Sandnes (NO)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/572,111

(22) PCT Filed: Sep. 16, 2004
(86) PCT No.: PCT/NO04/00274

§ 371 Date: Mar. 16, 2006

(30) Foreign Application Priority Data
Sep. 16, 2003 (NO) 200334132

(51) Int. Cl. B65D 51/16; A47G 19/22; B65D 83/00; F16K 15/00

(52) U.S. Cl. 220/203.11; 137/455; 220/714; 220/717; 215/387

(57) ABSTRACT

This invention concerns a valve for an underpressure-activated outflow mechanism for a drinking receptacle (2). The valve includes a valve head (34) and a valve seat (44), in which the valve seat (44) is arranged in force-transmitting connection with a membrane (1), whereas the valve head (34) is fixed to the remaining structure via at least one stay (36).

This invention concerns an underpressure-activated outflow mechanism in a valve for a drinking receptacle. The valve includes a valve head and a valve seat, where the valve seat is arranged in force-transmitting connection with a membrane, whereas the valve head is fixed to the remaining structure.

The patent literature discloses several devices that utilize underpressure for activating a valve for a drinking receptacle, for example as shown in U.S. Pat. No. 6,290,090 and in Norwegian patent no. 315182. Common to all prior art in this area is that the valve seat is fixed to the structure, and that only the sealing surface of the valve head can be moved or change shape during activation. First and foremost the present invention seeks to improve the manufacture and cost related aspects of existing technology. Making the valve seat moveable renders possible to obviate the need for the valve head requiring horizontal sealing surfaces that must be pulled out of the casting mould after moulding, thus bringing about a risk of inflicting damage thereto. Normally the valve surface may also become damaged during assembly, inasmuch as it becomes strongly deformed when being forced through a valve opening. Using currently available methods for inspecting this surface increases both cost and complexity.

The object of the invention is to remedy said disadvantages of prior art. The object is achieved in accordance with the features disclosed in the following description below and in the subsequent claims.

The valve differs substantially from existing technology in that it includes a valve seat that is arranged movably suspended relative to the valve head itself, and relative to the remaining structure. The membrane is arranged in force-transmitting connection with the valve seat. When a user sucks an underpressure P2 on one side of the membrane, thereby causing it to move or deform, a substantially axial suction force is transmitted to the valve seat and moves it. Due to the valve head being fixed to the substantially non-moveable part of the structure, the valve seat is moved away from the valve head and opens the valve to outflow, cf. attached figures.

Another particular feature of the invention is that it utilizes a flexible or movable seal between the pressure zone P3 of the drinking receptacle and the atmospheric reference pressure P1. The seal may be formed so as to be pressure-affectable by the bottle pressure, thereby allowing the bottle pressure to exert an elevated closing pressure when the pressure increases. It may also be formed with a vertical tubular or cone-shaped zone, thereby allowing it to expand radially during influence of pressure, thus reducing the axial extent thereof. This function may be used to counteract or balance the valve closing pressure, thereby reducing the required opening force from the membrane during high-pressure activation.

It is also an object of the invention to provide a structure that is simpler to manufacture, and which can withstand high pressure. According to prior art, a flexible and pressure-affectable membrane structure may be used, in which the same soft material is also utilized to form a valve head. The forces arising in response to pressure P3 in the drinking receptacle therefore must be transmitted via the soft sealing flange of the valve head to a stationary valve seat, or to other parts of the relatively soft membrane. According to the present invention, these forces substantially will be transmitted directly to the rigid part of the structure via the valve head and the suspension thereof, which represents a structural advantage, cf. the figures.

The invention may be provided, as needed, with a protective top cover or other special technical adaptations. This especially concerns the choice of connection methods to the drinking receptacle and the design of flanges and snap-connections between the parts constituting the device itself. Threads and/or flanges may be adapted for use on all types of drinking receptacles, such as bottles, cartons, bags, cups, feeding bottles, etc. If the device is to be adapted for easy cleaning and reuse, the individual parts may be provided with, for example, threads instead of snap-connections. The device is intended for use with all types of liquid food substances, also including pressurized drinks, hot drinks, liquid food, ice cream and so forth.

In principle, the invention can be utilized together with all known types of membranes, for example with flat, circular and radially suspended membranes, or with membranes having a conical shape projecting into the vertical plane. The membranes may have both symmetrical as well as asymmetrical shapes and may include several materials, for example combinations of rigid ribs or portions transmitting force, and also soft plastics allowing radial compression of the membrane.

In the following, several non-limiting examples of preferred embodiments are described, in which these embodiments are shown as vertical sections in the accompanying drawings, in which:

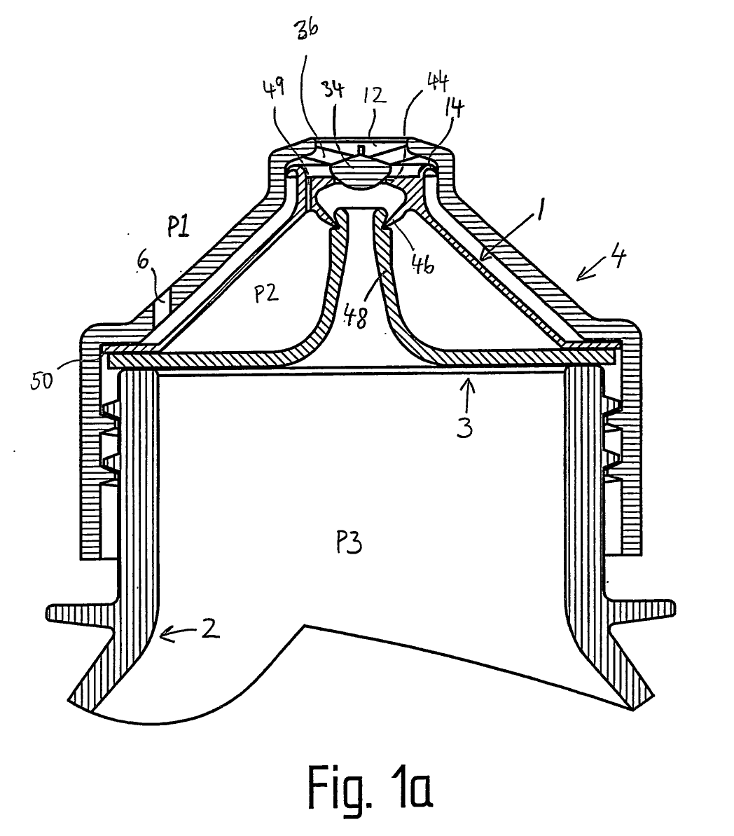

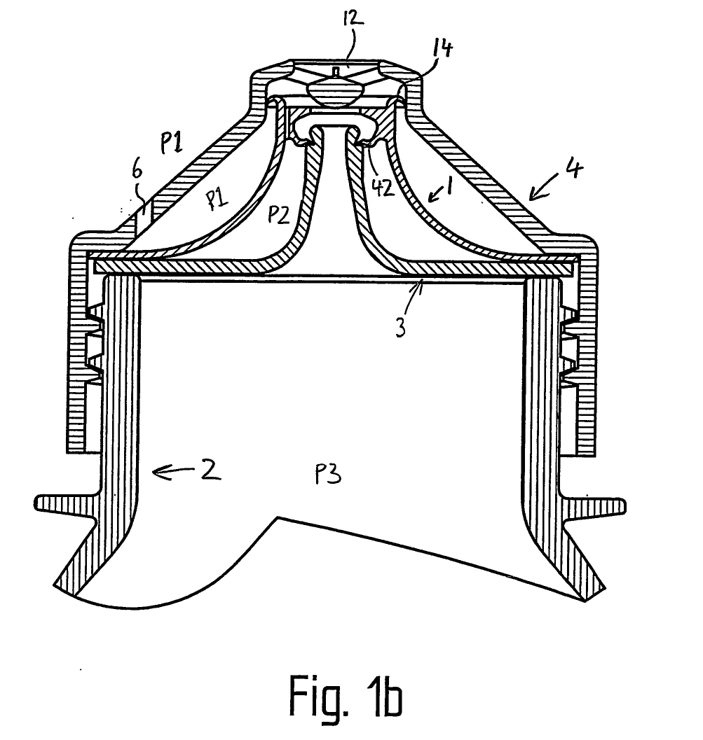

FIGS. 1a-1b show one embodiment of the valve device according to the invention being arranged in a screw cap, in which the valve is shown in a closed and an open position, respectively;

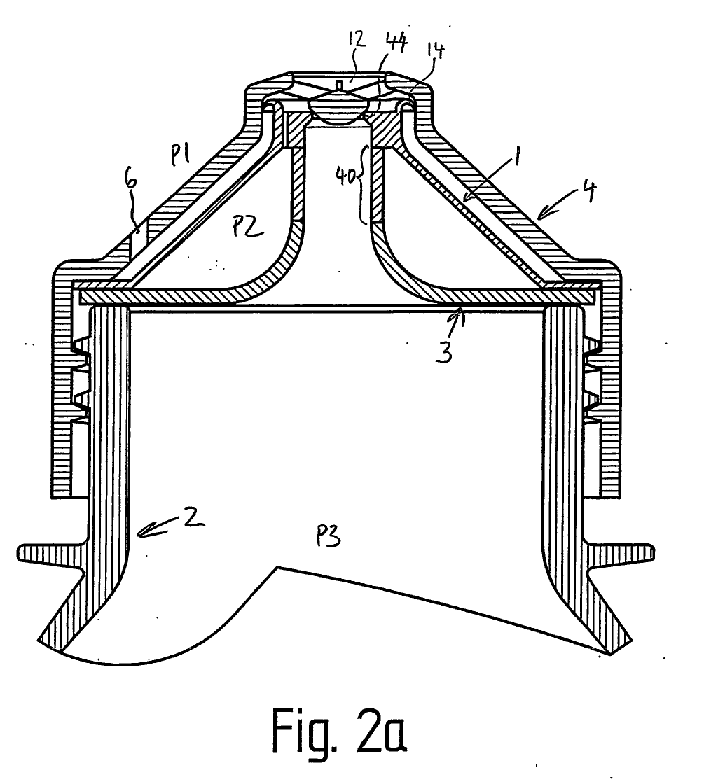

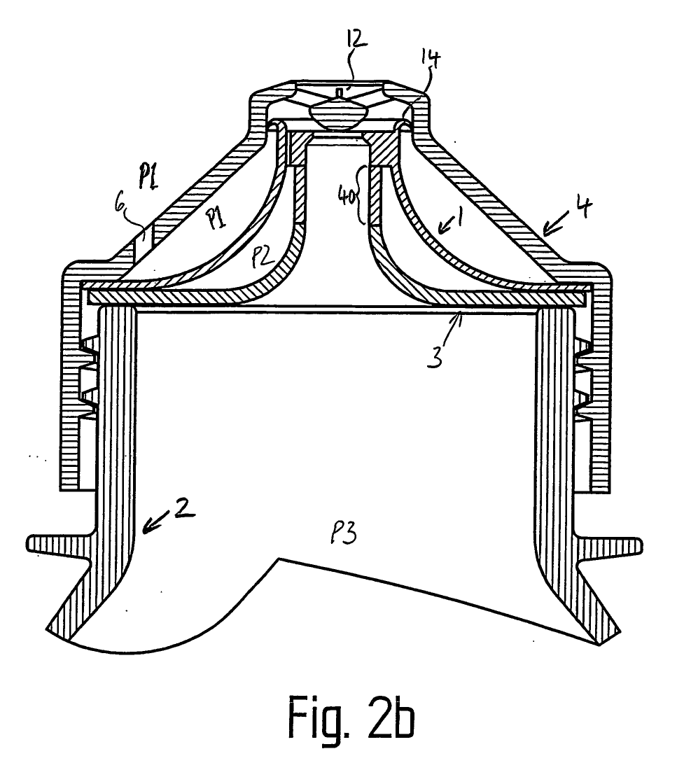

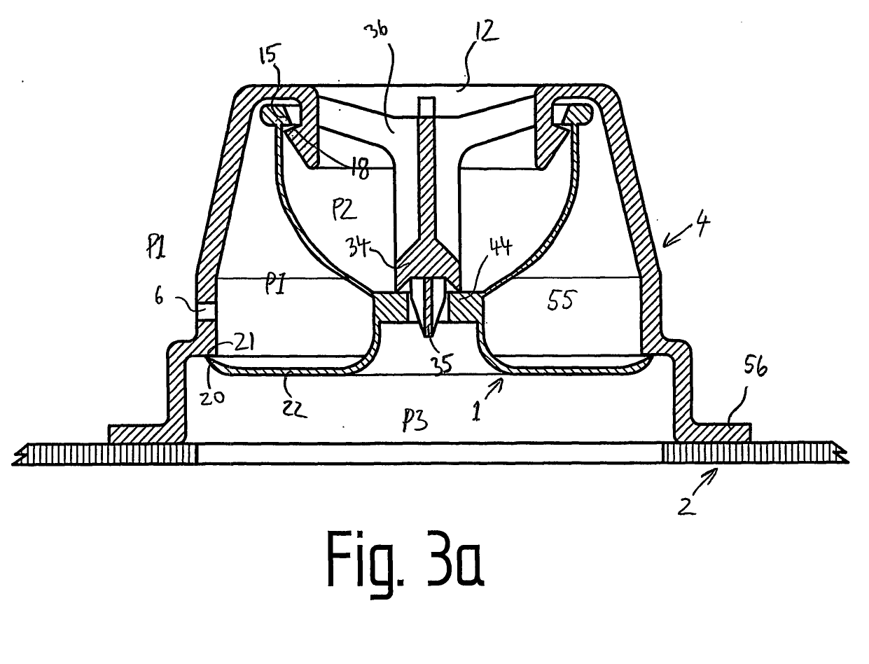

FIGS. 2a-2b show an alternative embodiment of the valve device according to the invention being arranged in a screw cap, in which the valve is shown in a closed and an open position, respectively;

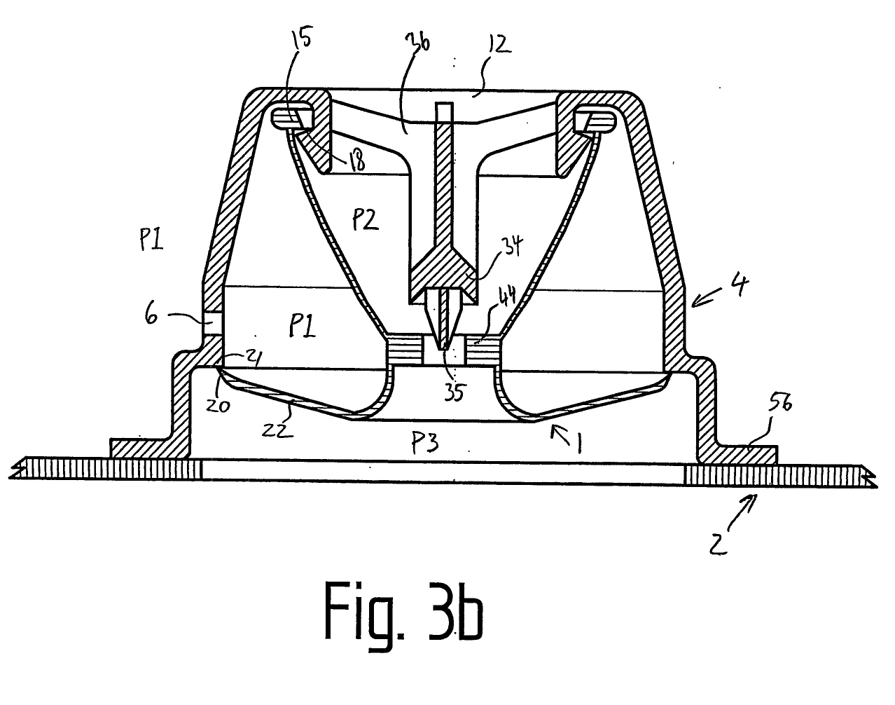

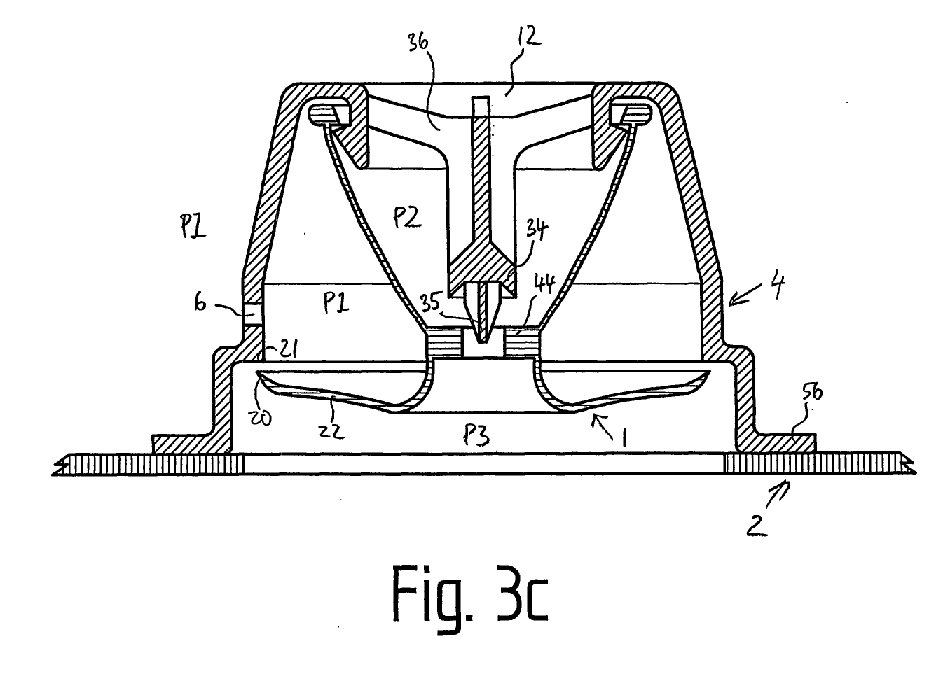

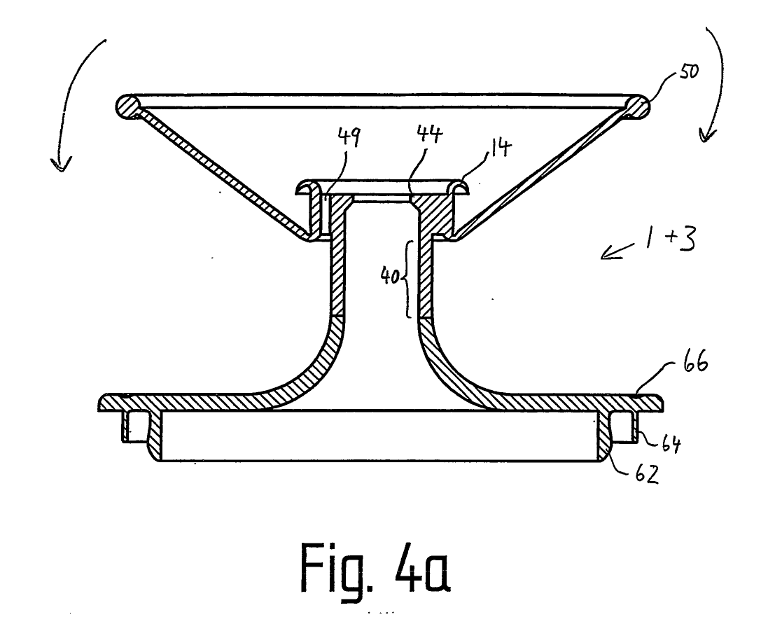

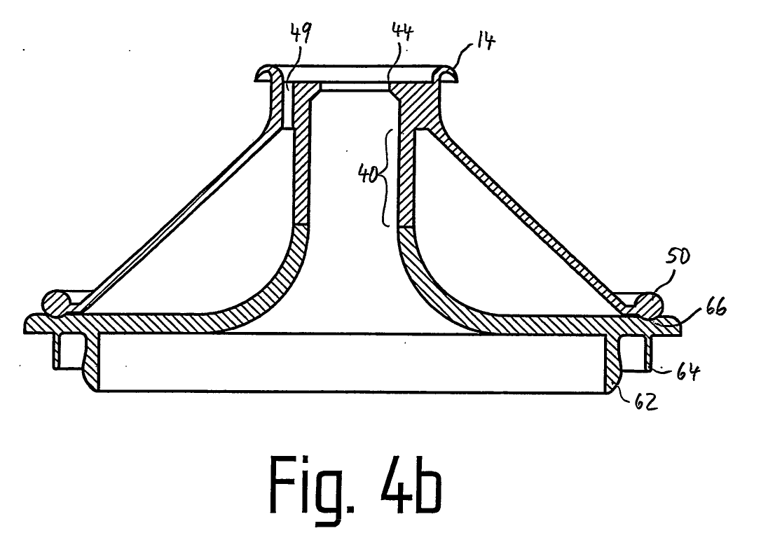

FIGS. 3a-3c also show an alternative embodiment of the valve device according to the invention being arranged in an enclosure, in which the valve is shown in a closed, an open and an open/venting position, respectively;

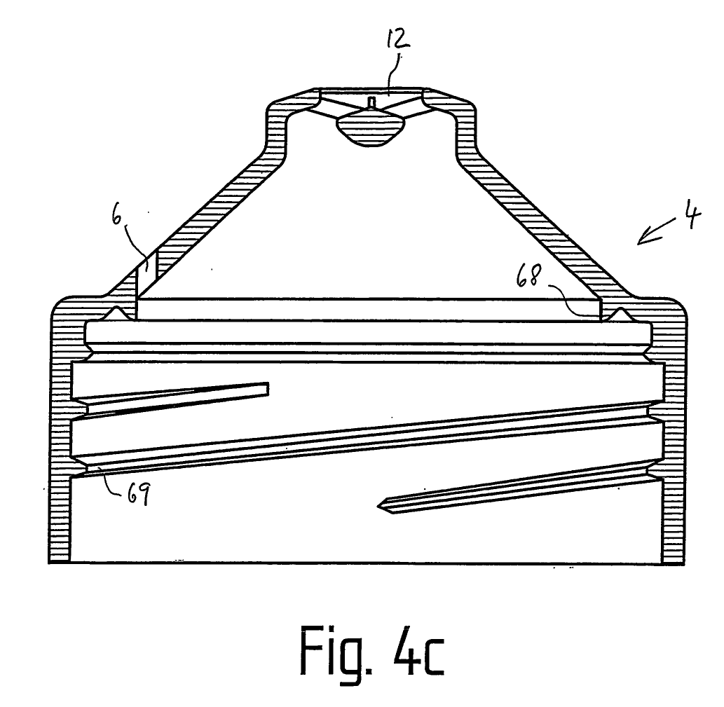

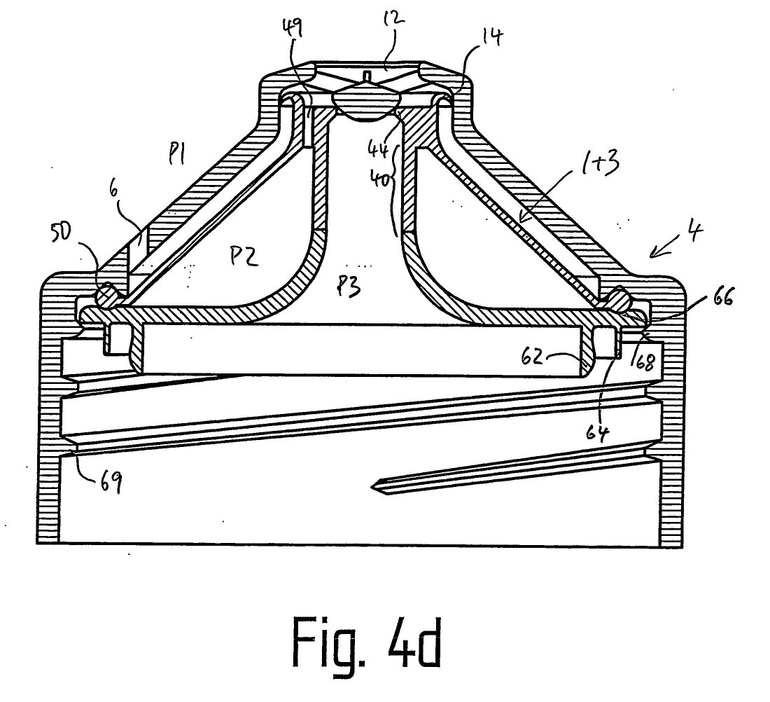

FIGS. 4a-4c show a valve device resembling the embodiment according to FIGS. 2a-2b, in which the figures show steps in the assembling of the valve device; FIGS. 4a-4c showing individual components of the valve device; while FIG. 4d shows the components after assembly, and where FIG. 4a shows a membrane part in the form it exists immediately after being removed from its casting mould.

FIG. 1a shows one embodiment of the valve device according to the invention, in which the device is connected to a drinking receptacle 2 being a bottle in this example. In its position of rest, the valve seat 44 will be in pressure-sealing contact with the valve head 34. The valve head 34 is fixed within the cap and/or to the remaining structure via one or more stays 36. When applying an underpressure P2 to the inside of the membrane 1 via the suction channel 49, the radial shape of the membrane 1 changes and becomes shorter axially. Due to the membrane 1 being fixed at its lower end 50, the resulting suction force will move the valve seat 44 away from the valve head 34, which is downwards on the figure, and open the valve to outflow. A seal 46 is also pressure-sealingly connected with the valve seat 44 and against an extruded, tubular channel 48 on a pressure-sealing partition wall 3 towards the drinking receptacle 2. A movable and/or flexible flange 14, which is pressure-sealingly connected with the valve seat 44, seals against the inside of a spout 12 formed in an enclosure 4 surrounding the valve on the outside of said screw cap. This sealing arrangement ensures that two separate pressure zones can exist in the valve during the activation thereof, in which one pressure zone has a pressure P1 (atmospheric pressure), and the other pressure zone has a pressure P2 (underpressure creating said suction force). When the suction force opens the valve, liquid will flow from the drinking receptacle 2 through the channel 48. When the suction force ceases, the valve will close, partly as a result of the elastic rigidity of the membrane, and partly as a result of the elastic deformation of the seal 46.

FIG. 1b shows the valve according to FIG. 1a in an open, underpressure-activated position.

FIG. 2a shows an alternative embodiment of the valve device according to the invention. In this embodiment, the seal 46 is replaced with a flexible zone 40. When the valve seat 44 moves towards the partition wall 3 during activation, the relatively soft and/or bellows-shaped zone 40 will be compressed and temporarily shortened in the axial direction thereof, thus forming a flexible, yet pressure-tight, liquid channel.

FIG. 2b shows the valve device according to FIG. 2a in an open, underpressure-activated, position.

FIG. 3ashows another embodiment of the valve device according to the invention. In this embodiment, the membrane 1 is arranged to contract radially upon underpressure-activation, thereby increasing its length axially. The axial extension of the membrane causes the valve seat 44 to move away from the valve head 34, which is down towards the drinking receptacle 2 on the figure, and open the valve to outflow. In this example, the drinking receptacle 2 may be a drinking carton, for example, in which only a wall portion thereof is shown on the figure. The valve head 34 shown herein is provided with a guide peg 35 centring the valve seat 44 relative to the valve head 34 during closing. The membrane 1 is shown pressure-sealingly suspended via its upper end 15 from a recess 18 in an outer enclosure 4 that is fixed to the drinking receptacle 2 around an opening therein. On the outside of the membrane 1, a pressure equalization space 55 exists being connected with atmospheric pressure P1 via at least one vent 6 in the wall of the surrounding enclosure 4.

FIG. 3b shows the valve device according to FIG. 3a in an open, underpressure-activated position. In this under-pressure-activated position, a pressure difference P1-P2 will act across the pressure-sensitive part of the membrane 1, causing a radial compression thereof and a resulting axial displacement of the valve seat 44.

FIG. 3c shows the valve device according to FIG. 3ain both the activated and the venting position. When an underpressure P3 arises in the drinking receptacle 2 during the liquid outflow, a flange seal 20 will move away from a sealing surface 21 and allow venting of the drinking receptacle 2 via said pressure-equalization space 55 and vent 6. The flange seal 20 is an outer sealing lip of a sealing flap 22 that is connected to the valve seat 44 and encircles the valve seat 44. The sealing surface 21 constitutes a portion of a shoulder formed on the inside of the enclosure 4. The venting may occur due to a pressure difference P1-P3 acting across the sealing flap 22, thereby introducing an inwardly directed force that moves the flange seal 20 away from the sealing surface 21. Venting of the drinking receptacle 2 is not restricted to only occur when the valve device is in an activated state, venting may also occur independently of this manner of venting.

According to another aspect of the invention, said membrane 1 may also be moulded in a spread-out Y-shape in a casting mould. Such a Y-shape appears in an axial cross section through the membrane 1, such as shown in FIG. 4a. Thus, the membrane 1 will assume this shape immediately after being removed from the casting mould. In this embodiment, said lower end 50 of the membrane 1 is formed as a ring gasket having a circular cross section. The Y-shaped membrane structure is very favourable in view of mass-producing the membrane 1. Having removed the Y-shaped membrane structure from the casting mould, the membrane 1 is deflected and folded into its normal shape of use, as shown in FIG. 4b. The folding may be carried out before or during assembly of the individual components of the valve device. FIG. 4c shows said screw cap and an outer enclosure 4 thereof. The enclosure is provided with said spout 12 wherein the valve head 34 is suspended via said stays 36. FIG. 4d shows all components after assembly thereof in the screw cap, in which the assembly is ready to be connected to a bottle (not shown).

1. A device of a valve for a drinking receptacle having an internal pressures, in which the valve is provided in an enclosure, a downstream end thereof being provided with a drinking opening, and an upstream end thereof being open and attached around an opening in the drinking receptacle when in position of use, whereby the valve may open and close to liquid outflow from the drinking receptacle via said drinking opening, which is provided downstream of the valve; in which the valve comprises:
a flexible membrane body provided with an attachment end fixedly connected to the enclosure when in position of use, and a free manoeuvre end pressure-sealingly and movably connected to the enclosure;
a valve head; and
a valve seat against which the valve head seals when the valve is inactive and in its position of rest;
in which the enclosure also contains:
a pressure balancing chamber communicating with an ambient pressure of the enclosure and one side of the membrane body; and
a suction chamber communicating with said downstream drinking opening and the other side of the membrane body;
in which the valve is arranged to open to said liquid outflow when the suction chamber, via said downstream drinking opening, is supplied an underpressure which is less than said ambient pressure by a predetermined value, whereby the membrane body is exposed to a pressure difference that activates and moves the membrane body with a valve-opening force, characterized in that the valve head is fixedly and by-passably connected to the enclosure;
wherein the valve seat is connected to the manoeuvre end of the membrane body;
wherein the valve seat is provided upstream of the valve head; and
wherein the valve seat is pressure-sealingly and movably connected to the enclosure;
whereby the valve seat may be moved away from the valve head sand open the valve to liquid outflow when the suction chamber is supplied said underpressure.

2. The device according to claim 1, characterized in that the membrane body has an axial extension and thus forms a sleeve-like body.

3. The device according to claim 2, characterized in that the sleeve-like body has a tubular, conical or approximately conical shape.

4. The device according to claim 1, characterized in that the attachment end of the membrane body is connected to the enclosure at or near the upstream end thereof, whereas the manoeuvre end of the membrane body is connected to the enclosure at or near the downstream end thereof.

5. The device according to claim 4, characterized in that the upstream side of the valve seat is flexibly connected to an outflow opening in a partition provided between the attachment end and the opening in the drinking receptacle, whereby said suction chamber is provided between the partition and the membrane body, whereas said pressure balancing chamber is provided between the membrane body and the enclosure; and
wherein the valve seat is provided with at least one connection channel connecting the suction chamber with the drinking opening.

6. The device according to claim 5, characterized in that the upstream side of the valve seat is provided with a flexible ring gasket arranged so as to engage pressure-sealingly around said outflow opening in the partition.

7. The device according to claim 6, characterized in that the outflow opening is provided in a free end of a tubular outflow channel, which projects out from the partition and forms a part thereof.

8. The device according to claim 5, characterized in that the upstream side of the valve seat is provided with a flexible sleeve, which is connected to said outflow opening in the partition.

9. The device according to claim 8, characterized in that the upstream end of the sleeve is connected to a tubular outflow channel, which projects out from the partition and forms a part thereof.

10. The device according to claim 1, characterized in that the valve seat is pressure-sealingly and movably connected to the enclosure via a flexible sealing collar provided on the outside of the valve seat.

11. The device according to claim 4, characterized in that the membrane body has a spread-out Y-shape when moulded and removed from a corresponding casting mould.

12. The device according to claim 1, characterized in that the attachment end of the membrane body is connected to the enclosure at or near the downstream end thereof, whereas the manoeuvre end of the membrane body is connected to the enclosure at or near the upstream end thereof.

13. The device according to claim 12, characterized in that the upstream side of the valve seat is pressure-sealingly and movably connected to the enclosure via a flexible sealing collar provided on the outside of the valve seat and projecting out therefrom;
said pressure balancing chamber thus being provided between the sealing collar, the membrane body and the enclosure, whereas the suction chamber is provided between the membrane body and said drinking opening in the enclosure.

14. The device according to claim 13, characterized in that the flexible sealing collar is connected to a sealing surface in the form of an internal shoulder in the enclosure.

15. The device according to claim 12, characterized in that the attachment end of the membrane body is releasably connected to the enclosure.

16. The device according to claim 15, characterized in that the attachment end and the enclosure are connected via a quick release coupling.

17. The device according to claim 16, characterized in that the quick release coupling is a snap coupling or a threaded connection.

18. The device according to claim 16, characterized in that the enclosure is provided with an internal collar defining said drinking opening; and
wherein the internal collar is provided with a first coupling element of the quick release coupling, whereas said attachment end is provided with a cooperating second coupling element of the quick release coupling.

19. The device according to claim 1, characterized in that the enclosure is provided with at least one vent into said pressure balancing chamber.

20. The device according to claim 1, characterized in that the valve head is connected to the enclosure via at least one stay.

21. The device according to claim 1, characterized in that at least one of the valve head and the valve seat is/are provided with, or is/are arranged as, a guiding device that centres the valve head in the valve seat during closing of the valve.
